(19) United States
(12) Patent Application Publication
(10) Pub. No.: US 2005/0014044 A1
(43) Pub. Date: Jan. 20, 2005

(54) Fuel cell system

(76) Inventors: Niranjan Thirukkovalur, Corvallis, OR (US); Peter Mardilovich, Corvallis, OR (US); Gregory S. Herman, Albany, OR (US); David Champion, Lebanon, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/620,863

(22) Filed: Jul. 15, 2003

(51) Int. Cl. H01M 8/04

(52) U.S. Cl. 429/26; 429/34; 429/13; 429/23; 429/38

(57) ABSTRACT

A fuel cell system in accordance with a present invention includes independently actuatable fuel cells.

### BACKGROUND OF THE INVENTIONS

1. Field of the Inventions

The present inventions are related to fuel cells.

2. Description of the Related Art

Fuel cells, which convert reactants (i.e. fuel and oxidant) into electricity and reaction products, are advantageous because they are not hampered by lengthy recharging cycles, as are rechargeable batteries, and are relatively small, lightweight and produce virtually no environmental emissions. Fuel cells are frequently used in systems that include a plurality of fuel cells. Such systems are scaleable and, accordingly, may be used to power everything from small electronic devices to entire factories depending on the type, size and number of fuel cells. The inventors herein have determined that conventional fuel cell systems are nevertheless susceptible to improvement. For example, the inventors herein have determined that the amount of time required to start conventional fuel cell systems, especially those which include a large number of fuel cells, can be excessive. Some small systems for portable electronic devices can take a few minutes to start up, while some large commercial systems can take up to a few hours.

### BRIEF DESCRIPTION OF THE DRAWINGS

Detailed description of embodiments of the inventions will be made with reference to the accompanying drawings.

FIG. 1 is a diagrammatic view of a fuel cell system in accordance with one embodiment of a present invention.

FIGS. 2A and 2B are diagrammatic views of fuel cells that may be used in conjunction with the fuel cell system illustrated in FIG. 1.

FIG. 3 is a flow chart illustrating an operational method in accordance with one embodiment of a present invention.

FIG. 4 is a diagrammatic view of a fuel cell system in accordance with one embodiment of a present invention.

FIG. 5 is a diagrammatic view of a portion of a fuel cell system in accordance with one embodiment of a present invention.

FIG. 6 is a diagrammatic view of a fuel cell system in accordance with one embodiment of a present invention.

FIG. 7 is a diagrammatic view of a system or device in accordance with one embodiment of a present invention.

### DETAILED DESCRIPTION OF THE EMBODIMENTS

The following is a detailed description of the best presently known modes of carrying out the inventions. This description is not to be taken in a limiting sense, but is made merely for the purpose of illustrating the general principles of the inventions. It is noted that detailed discussions of fuel cell structures that are not pertinent to the present inventions have been omitted for the sake of simplicity. The present inventions are also applicable to a wide range of fuel cell technologies and fuel cell systems, including those presently being developed or yet to be developed. For example, although various exemplary fuel cell system are described below with reference to solid oxide fuel cells (“SOFCs”), other types of fuel cells, such as proton exchange membrane (“PEM”) fuel cells, are equally applicable to the present inventions. The present inventions are also applicable to fuel cell systems in which the fuel supply can be replenished and to systems in which all of the fuel that will be consumed is initially present in the system (sometimes referred to as “batteries”).

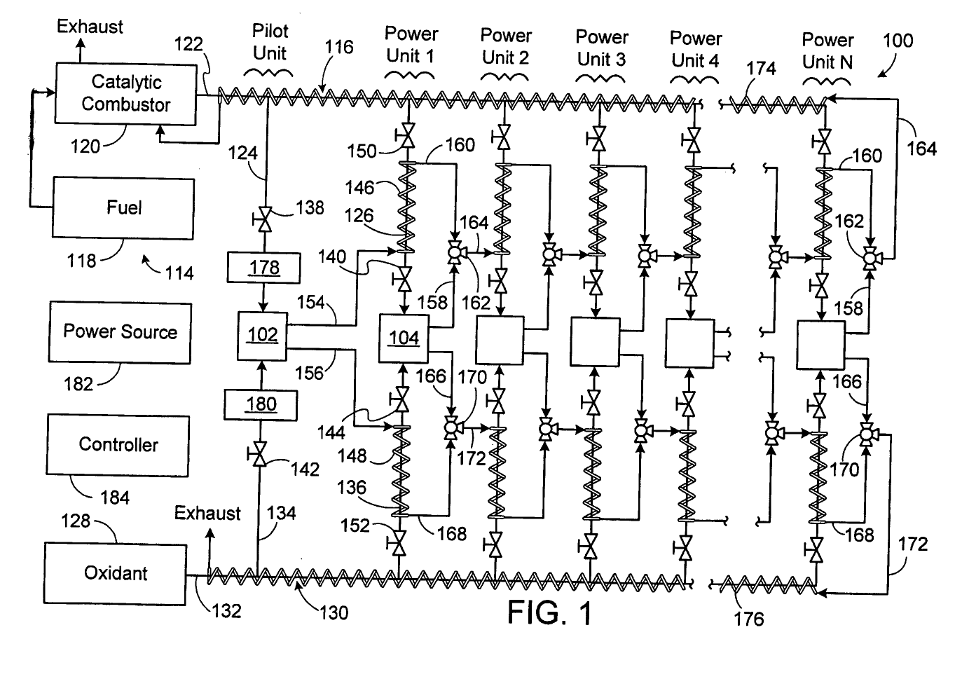

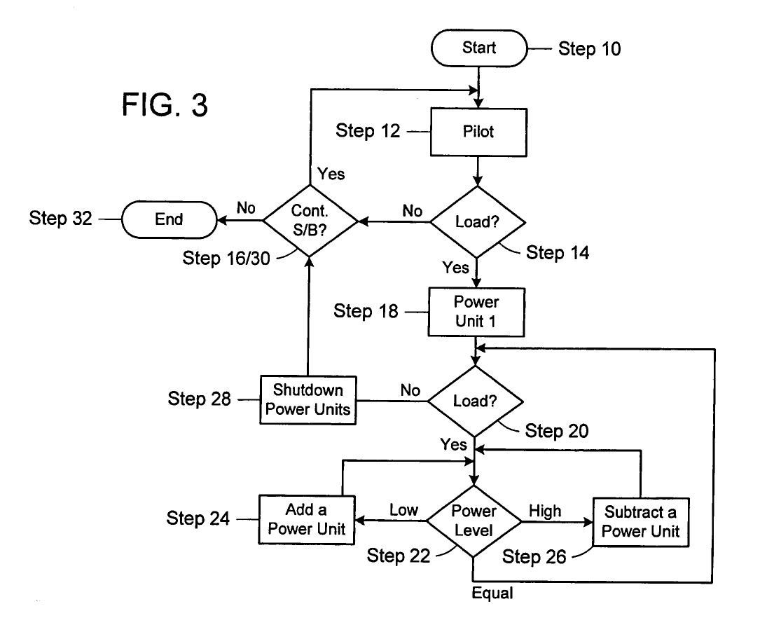

A fuel cell system 100 in accordance with one embodiment of a present invention is illustrated in FIG. 1. The exemplary fuel cell system 100 includes a pilot unit and a plurality of power units. The pilot unit and power units and each of the power units are preferably independently operable, i.e. one may be actuated without actuating others. As discussed in greater detail below, the pilot unit will be typically activated when the system 100 is placed in a standby state and will continue to run when the system supplying power to a load. The power units, on the other hand, will typically not be activated until the system is switched into the power supply state and is supplying power (or is about to supply power) to the load. Additionally, the power units may be activated in a predetermined sequence, such as that discussed below with reference to FIG. 3, in order to reduce startup time and increase the flexibility and efficiency of the system.

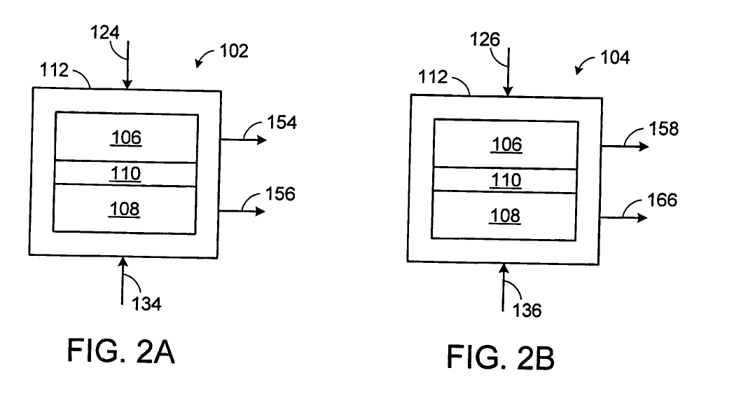

The pilot unit includes a fuel cell 102 and the power units each include a fuel cell 104. Although the present inventions are not so limited, the fuel cells 102 and 104 in the exemplary implementation are substantially identical solid oxide fuel cells that include an anode 106 and a cathode 108 separated by an electrolyte 110. [Note FIGS. 2A and 2B.] The fuel cells 102 and 104 are preferably enclosed within housings 112 which have fuel and oxidant inlet and outlet manifolds (not shown). Fuel from a fuel supply arrangement 114 is supplied to each of the anodes 106 by way of a fuel manifold 116. Suitable fuels include H₂ and hydrocarbon fuels such as CH₄, C₂H₆, C₃H₈, etc. The exemplary fuel supply arrangement 114 consists of a fuel source 118 and a catalytic combustor 120. The fuel passes through a fuel manifold common line 122 and then through a pilot unit feed line 124 or one of the power unit feed lines 126. Oxidant, such as O₂ or ambient air, from an oxidant supply 128 is supplied to each of the cathodes 108 by way of an oxidant manifold 130. In those instances where ambient air is used, the oxidant supply may simply be a vent or a vent and fan arrangement. The oxidant passes through an oxidant manifold common line 132 and then through a pilot unit feed line 134 or one of the power unit feed lines 136. The oxidant is electrochemically ionized at the cathodes 108, thereby producing ions that diffuse through the conducting electrolytes 110 and react with the fuel at the anodes 106. Each of the fuel cells includes suitable current collectors and the individual cells may be connected to one another in series or parallel depending on load.

Although the materials, dimensions, and configuration of the fuel cells in the exemplary fuel cell systems will depend upon the type of fuel cell (e.g. SOFC, PEM, etc.) and intended application, and although the present inventions are not limited to any particular materials, dimensions, configuration or type, exemplary fuel cells are described below. The exemplary fuels cells are relatively small (e.g. about 10 μm×10 μm to about 5 cm×5 cm) SOFCs which are manufactured using micro electrical mechanical systems (MEMS) based technology. The exemplary fuel cells are also preferably “thin” (i.e. between about 30-800 μm thick). The anodes are preferably a porous, ceramic and metal composite (also referred to as “cermet”) film that is about 1-100 μm thick. Suitable ceramics include samaria-doped ceria (“SDC”), gandolinia-doped ceria (GDC) and yttria stabilized zirconia (“YSZ”) and suitable metals include nickel and copper. The cathodes are preferably a porous ceramic film that is about 1-100 μm thick. Suitable ceramic materials include samarium strontium cobalt oxide (“SSCO”), lanthanum strontium manganate, bismuth copper substituted vanadate. The electrolytes are preferably a non-porous ceramic film, such as SDC, GDC or YSZ, that is about 1-100 μm thick.

The present fuel cell systems may also be provided with a valve arrangement that individually controls the flow of reactants to the individual fuel cells. To that end, the exemplary system 100 illustrated in FIG. 1 is provided with a fuel inlet valve 138 which controls the flow of fuel into the pilot unit fuel cell 102 and a plurality of fuel inlet valves 140 which control the flow of fuel into the power unit fuel cells 104. The exemplary system 100 also includes an oxidant inlet valve 142 which controls the flow of oxidant into the pilot unit fuel cell and a plurality of oxidant inlet valves 144 which control the flow of oxidant into the power unit fuel cells. The exemplary inlet valves are on-off valves, but may be of the type that controls flow rate if desired.

Fuel cell systems in accordance with the present inventions may also be configured such that the relatively hot byproducts and unused reactants (if any) from one or more of the fuel cells, which is referred to herein as “output,” is used to preheat the reactants that have not yet reached the fuel cells. For example, the output from one or more of the fuel cells may be used to heat the fuel and oxidant within the fuel and oxidant manifolds 116 and 130. More specifically, each of the power unit fuel feed lines 126 in the exemplary system 100 illustrated in FIG. 1 is provided with a fuel heater 146 and each of the power unit oxidant feed lines 136 is provided with an oxidant heater 148. The fuel and oxidant heaters 146 and 148 are preferably, but not necessarily, counter flow heat exchangers in which the heated output from the anodes and cathodes of one or more upstream fuel cells flows in the opposite direction as the fuel and oxidant flowing through the fuel and oxidant feed lines 126 and 136. The fuel and oxidant heaters 146 and 148 are also preferably associated with the portions of the fuel and oxidant feed lines 126 and 136 that are upstream from the valves 140 and 144. It should be noted here that the fuel and oxidant within the feed lines 126 and 136 may be isolated from the fuel and oxidant in the common lines 122 and 132 prior to actuation of the associated fuel cells 104 in order to improve the efficiency of the heating process. In those instances where such isolation is desired, the fuel and oxidant feed lines 126 and 136 may be provided with isolation valves 150 and 152, which are upstream of the fuel and oxidant heaters 146 and 148. The exemplary isolation valves 150 and 152 are also on-off valves, but may be of the type that controls flow rate if desired.

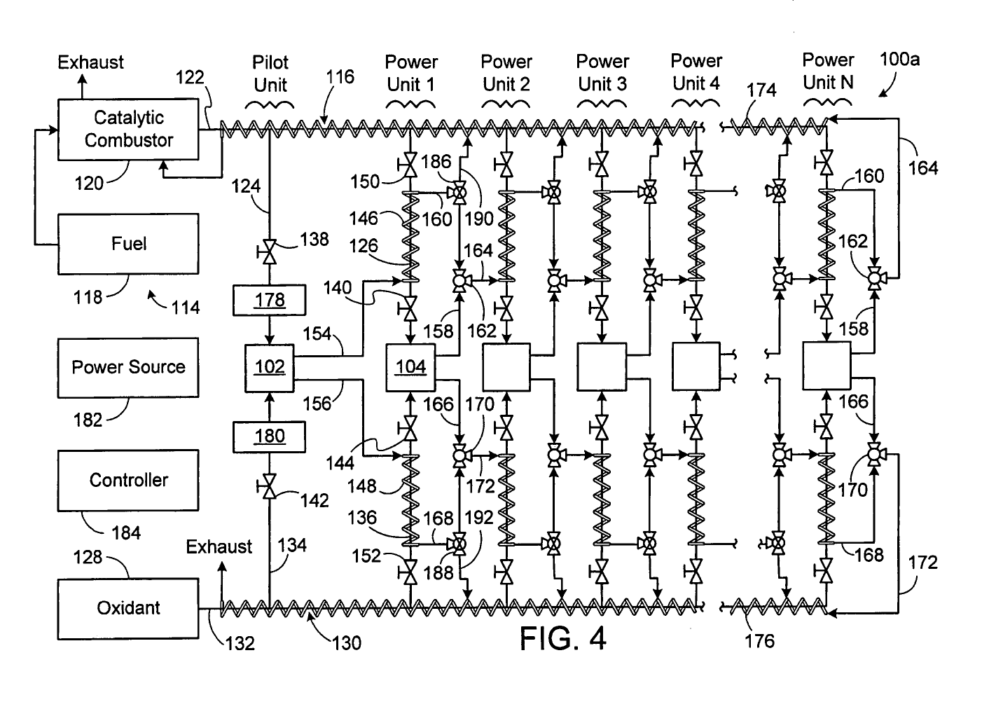

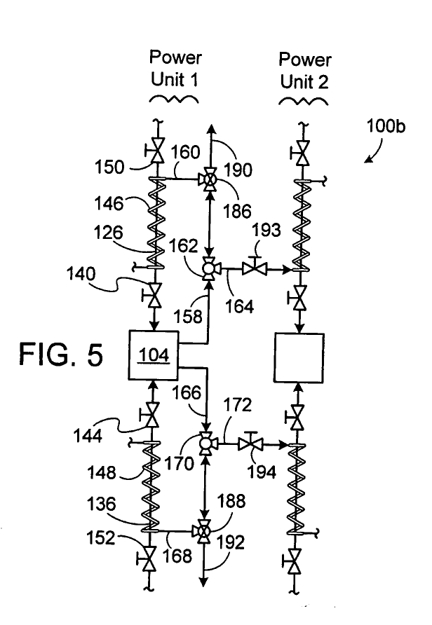

The anode output from the pilot unit fuel cell 102 in the exemplary system 100 is directed to inlet of the fuel heater 146 in the first power unit by way of an outlet line 154, while the cathode output from the pilot unit fuel cell is directed to inlet of the oxidant heater 148 in the first power unit by way of an outlet line 156. After passing through the fuel and oxidant heaters 146 and 148 in the first power unit, thereby heating the fuel and oxidant in the feed lines 126 and 136, the output from the pilot unit fuel cell 102 will continue through system 100 in the manner described below. Alternative arrangement are discussed below with reference to FIGS. 4 and 5.

Turning to the output from the power unit fuel cells 104 in the exemplary system 100, the anode output from the first power unit fuel cell 104 is combined with the anode output that has passed through the first power unit fuel heater 146 by way of outlet lines 158 and 160 and a mixing T-connector 162 that is configured to prevent backflow into the outlet lines. The combined output then enters the inlet of the fuel heater 146 in the next power unit by way of an inlet line 164. Similarly, the cathode output from the first power unit fuel cell 104 is combined with the cathode output that has passed through the first power unit oxidant heater 148 by way of outlet lines 166 and 168 and a mixing T-connector 170 that is configured to prevent backflow into the outlet lines. The combined output then enters the oxidant heater 148 in the next power unit by way of an inlet line 172. The anode and cathode outputs from the fuel cells 102 and 104 and fuel and oxidant heaters 146 and 148 will continue to be combined in this manner until the last power unit. In those instances where one or more of the power units have not been activated, there will of course not be output from the fuel cells 104 in those unit and the no additional output will be added to that which has passed through the previous heaters.

At the last power unit in the exemplary system 100, the anode and cathode outputs from the fuel cell 104 are combined with the output that has passed through fuel and oxidant heaters 146 and 148 output are combined by way of mixing T-connectors 162 and 170. The combined outputs are then fed into heaters 174 and 176 (e.g. countercurrent heat exchangers) that respectively heat the fuel within the fuel manifold main line 122 and the oxidant within the oxidant manifold main line 132. The output from the fuel manifold main line heater 174 may be used to supply heat to the catalytic combustor 120 (as shown) through the use of a heat exchanger or vented prior to the catalytic combustor, while the output from the oxidant manifold main line heater 176 may be vented (as shown) or used to supply heat to the catalytic combustor.

The exemplary implementation also includes a pair of heaters 178 and 180 for heating the fuel and oxidant supplied to the pilot unit fuel cell 102. Power for the heaters 178 and 180 is provided by a power source 182 such as a rechargeable battery and/or a capacitor, which may also be used to store unused power from the fuel cells 102 and 104. The heaters 178 and 180 may be eliminated in those instances where the fuel and oxidant are to be supplied to the pilot unit fuel cell 102 at ambient temperature.

The operation of the exemplary fuel cell system 100 may be monitored and controlled by the controller 184 or by the host (i.e. power consuming) system or device. In either case, and as noted above, the exemplary fuel cell system 100 is operable in a standby state, where only the pilot unit is operating, and a power supply state, where one or more of the power units are also operating so that power can be supplied to the load. When the system 100 is not operating (i.e. not supplying power or in the standby state), all of the valves will be closed.

One exemplary control scheme is illustrated in FIG. 3. The system 100 will initially be placed in the standby state is when started (Step 10) and, accordingly, the pilot unit will be activated (Step 12). More specifically, and referring also to FIG. 1, the valves 138 and 142 are opened and the heaters 178 and 180, which are powered by the power source 182, are activated when the system 100 is placed in the standby state so that fuel and oxidant at the proper reaction temperature will be supplied to the pilot unit fuel cell 102. Although the fuel and oxidant inlet valves 140 and 144 in each of the power units will remain closed, the fuel and oxidant isolation valves 150 and 152 in the first power unit will open briefly. This allows the portions of the fuel and oxidant feed lines 126 and 136 associated with the fuel and oxidant heaters 146 and 148 in the first power unit to be filled with fuel and oxidant. The fuel and oxidant isolation valves 150 and 152 will then close to isolate the fuel and oxidant from the fuel and oxidant in the manifolds 116 and 130. The power produced by the reaction at the pilot unit fuel cell 102 will be stored by the power source 182. Additionally, the anode and cathode output from the pilot unit fuel cell 102 will pass through the fuel and oxidant heaters 146 and 148 in the first power unit to heat the fuel and oxidant isolated within the fuel and oxidant feed lines 126 and 136. The anode and cathode output will also pass through the fuel and oxidant heaters in the remaining power units, and through the manifold main line heaters 174 and 176, before being vented out of the system 100. The anode and/or cathode output may also be used as a source of heat for the catalytic combustor 120 in some implementations. The exemplary system 100 will remain in the standby state until a load is applied (Step 14) or the system is turned off (Step 16).

In accordance with the exemplary control scheme illustrated in FIG. 3, the fuel cell system 100 will automatically go from the standby state to the power supply state when a load is applied to the system (Step 18). The valves 140 and 144 in the first power unit will then open in order to allow the preheated fuel and oxidant into the fuel cell 104, thereby immediately bringing the fuel cell to operating temperature and initializing the fuel cell reaction. It should be noted here that the valves 140 and 144 should not be opened until the associated fuel and oxidant has been brought to the desired temperature, which may be determined with temperature sensors or by simply waiting for a predetermined heating period. The valves 150 and 152 in the first power unit will also open in order to allow fuel and oxidant from the manifolds 116 and 130 to flow through the feed lines 126 and 136, and past to the heaters 146 and 148, to the fuel cell 104 so that it may continue to operate. As the reaction within fuel cell 104 in the first power unit continues, power will be supplied to the load and excess power, if any, will be stored by the power source 182. The anode and cathode output from the first power unit fuel cell 104 is respectively combined with the anode and output from the pilot unit fuel cell 102 (which has passed through the heaters 146 and 148) at the mixing T-connectors 162 and 170.

The combined output from the first power unit may then be used by the heaters 146 and 148 in the second power unit to preheat the fuel and oxidant. As such, and although the fuel and oxidant inlet valves 140 and 144 in second power unit will remain closed, the fuel and oxidant isolation valves 150 and 152 in the second power unit will open briefly. This allows the portions of the fuel and oxidant feed lines 126 and 136 associated with the fuel and oxidant heaters 146 and 148 in the second power unit to be filled with fuel and oxidant so that the fuel and oxidant may be preheated prior to the actuation of the second power unit. The anode and cathode output will also pass through the remaining power units and be vented or used in the manner described above.

The pilot unit and first power unit will continue to operate in this manner so long as there is a load on the exemplary system 100 and the load is less than the level of power generated by the fuel cells 102 and 104 (Steps 20 and 22). If the power level generated by the fuel cells in pilot unit and first power unit is less than the load, the second power unit will be activated and the reactants for third power unit will be begin the preheating process in the manner described above (Step 24). The sequential activation of additional power units, and preheating of the reactants in the next non-activated power unit, will continue until the power generated by the system 100 is sufficient to handle the load, or the last (i.e. N^{th}) power unit has been activated. If, on the other hand, more than one power unit has been activated and the load has dropped to such a level that the operation of one or more of the power units is no longer needed, the power units will be sequentially deactivated until the generated power level corresponds to the load (Step 26). If the load is completely removed, the power units will be deactivated (Step 28), while the pilot unit will continue to operate if the system 100 is to remain in the standby state (Step 30). Otherwise, the pilot unit will also be deactivated (Step 32).

There are a number of advantages associated with the present systems and methods. For example, breaking a large multi-fuel cell system into a number of smaller units and starting them sequentially allows the present systems to begin supplying power much faster than large systems in which all of the fuel cells are started simultaneously. The present system will begin supplying power to a load as soon as the number of fuel cells required to power that load have been activated, as opposed to having to wait for all of the fuel cells within a system to be activated regardless of the magnitude of the load, as is the case in conventional systems. Additionally, employing output from a pilot cell to preheat one or more of the other cells further reduces the startup time of the present systems. Using the output from activated power unit fuel cells to preheat the reactants for fuel cells that are about to be activated not only reduces startup time, but also improves the overall efficiency of the system and eliminates the need for the relatively large heaters that are required to bring many large multi-fuel cell systems up to their operating temperature. The modular design of the present inventions also provides increased design and manufacturing flexibility. For example, in those instances where each fuel cell is the same size, manufacturing complexity is greatly reduced.

The present inventions are, of course, not limited to the exemplary control scheme described with reference to FIG. 3. For example, in those instances where the load is a known value, the system could be configured to automatically activate the proper number power units (preferably one at a time, but as quickly as possible) and then monitor the load thereafter.

The exemplary system fuel cell system 100 illustrated in FIG. 1 may also be modified in a variety of ways. For example, the fuel cell system 100a illustrated in FIG. 4 is substantially identical to the fuel cell system 100 illustrated in FIG. 1 and similar elements are identified by similar reference numerals. Here, however, the system is provided with control valves 186 and 188 which regulate the flow of the anode and cathode output after it passes through the heaters 146 and 148 in each power unit. The control valves 186 and 188 allow the system 100a to selectively redirect the anode and cathode output to the fuel and oxidant manifold main line heaters 174 and 176. More specifically, the control valves 186 and 188 allow the system to more efficiently use the heat in the anode and cathode output by bypassing some or all of the heaters 146 and 148 in power units that are not about to be actuated. The control valves 186 and 188 are connected to the fuel and oxidant manifold main line heaters 174 and 176 by lines 190 and 192.

For example, and assuming that the fuel cell system 100a illustrated in FIG. 4 is in standby mode, the anode and cathode output from the pilot unit fuel cell 102 will be directed into the heaters 146 and 148 in the first power unit. The control valves 186 and 188 may be used to direct the anode and cathode output that has passed though the first power unit heaters 146 and 148 directly into the fuel and oxidant manifold main line heaters 174 and 176 instead of into the mixing T-connectors 162 and 170 and on to the heaters in the remaining power units. The anode and cathode output from the pilot unit fuel cell 102 will only be used to preheat the fuel and oxidant that will enter the fuel cell 104 in the first power unit when it is initiated, the fuel and oxidant in the manifold main lines 122 and 132, and possibly, used to supply heat the catalytic combustor 120. Once the first power unit is activated, the control valves 186 and 188 associated with the heaters 146 and 148 in the first power unit will switch and direct the anode and cathode output that has passed therethrough to the mixing T-connectors 162 and 170 so that the fuel and oxidant that will be entering the fuel cell 104 in the second power unit can be preheated by the second power unit heaters 146 and 148. The control valves 186 and 188 associated with outlets of the second power unit heaters 146 and 148 may be used to direct the anode and cathode output from the fuel cells 102 and 104 into the fuel and oxidant manifold main line heaters 174 and 176. The remainder of control valves 186 and 188 may be used in this manner until each of the power units has be activated, and may be used in a similar fashion as individual power units are deactivated.

Turning to FIG. 5, the fuel cell system 100b which is partially illustrated therein is substantially identical to the fuel cell system 100a illustrated in FIG. 4 and similar elements are identified by similar reference numerals. Here, however, the system is provided with inlet valves 193 and 194 between the outlet of the mixing T-connectors 162 and 170 associated with one power unit and the inlet of the heaters 146 and 148 in the next power unit. Such an arrangement allows the system 100b to, for example, selectively divert all of the anode and cathode output from the pilot unit fuel cell 102 and any activated power unit fuel cells 104 away from the heaters 146 and 148 of the non-activated cells and into the fuel and oxidant manifold main line heaters 174 and 176. Such diversion would be useful in those situations where it is determined that the next power unit will not be activated in the near future. The inlet valves 193 and 194 would be opened, thereby allowing the anode and cathode output to flow into the next heaters 146 and 148, when it is determined that the associated power unit is about to be activated.

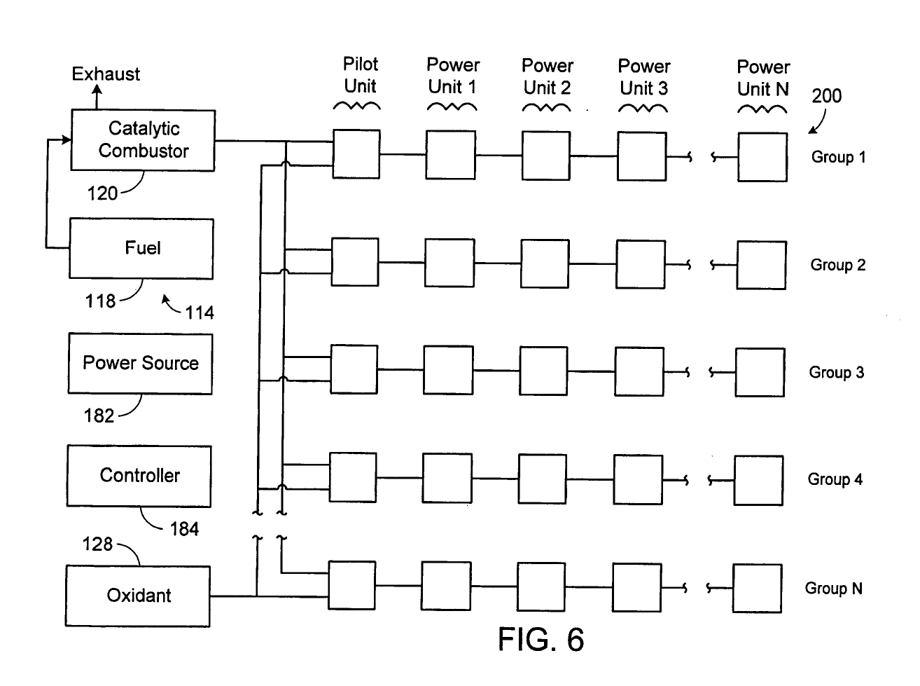

The number of power units in a particular fuel cell system in accordance with the present inventions will vary depending on the type and size of fuel cells employed in the system and the intended application. For each combination of fuel cell type and size there will, of course, be a physical limit to the number of power units that may be arranged in series (in the context of fuel cell output flow, but not necessarily in the electrical context) in the manner illustrated for example in FIGS. 1, 4 and 5. Should the power requirements of the intended application require more power than the maximum number of serially connected power units can deliver, a plurality of parallel power unit groups may be provided in the manner illustrated, for example, in FIG. 6. The exemplary fuel cell system 200 includes a plurality of power unit groups, each of which has its own pilot unit. The pilot and power units in each group may be connected in the manner described above with reference to systems 100, 100a and 100b. The electrical connection of the power units within each group, and the electrical connection of one power unit group to another, will depend on the load. In the illustrated embodiment, there is a common fuel supply arrangement 114, oxidant supply 128, and power source 182 for all of the power unit groups. Alternatively, each of the power unit groups, or subsets of the groups, may have its own fuel supply arrangement 114, oxidant supply 128, and/or power source 182. Each of the power unit groups in the exemplary system 200 also has its own pilot unit. Alternatively, a common pilot unit may be provided for each of the power unit groups, or subsets of the groups.

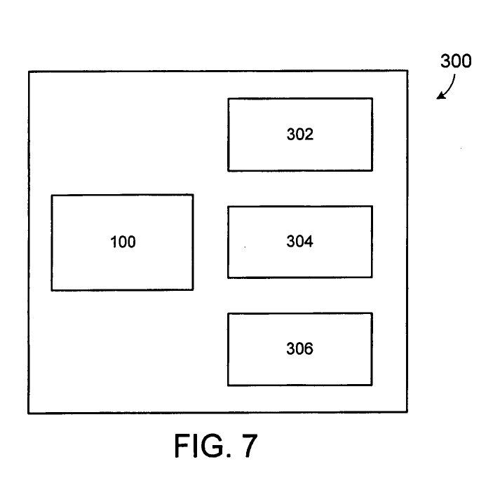

The present inventions also include a wide variety of electrically powered devices and systems including, but not limited to electronic devices (e.g. notebook computers, personal digital assistants, digital cameras, portable telephones and games), vehicles, factories, homes, relatively small portable power generators, such as those used for camping, and relatively large portable power generators used in commercial applications, which are powered at least in part by one of the aforementioned fuel cell systems. Turning to FIG. 7, an exemplary device or system 300 includes a fuel cell system 100 and various power consuming apparatus 302, 304 and 306.

Although the present inventions have been described in terms of the embodiments above, numerous modifications and/or additions to the above-described embodiments would be readily apparent to one skilled in the art. By way of example, but not limitation, different types fuel cells may be used for the pilot unit and power unit fuel cells. Additionally, instead of individual cells, the pilot and/or power units may be provided with fuel cell stacks. Single chamber fuel cells may also be employed. Another alternative is to place the feed lines 126 and 136 in close proximity to one another so that a single heater could be used to heat both the fuel and oxidant that enters the power unit fuel cells 104. It is intended that the scope of the present inventions extend to all such modifications and/or additions.

1. A fuel cell system, comprising:
at least first and second fuel cells, each of the fuel cells having at least one reactant inlet line and at least one output outlet; and
a first heater arrangement operably connected to the at least one output outlet of the first fuel cell and associated with the at least one reactant inlet line of the second fuel cell such that heat from the first heater arrangement is transferred to reactants in the at least one reactant inlet line of the second fuel cell.

2. A fuel cell system as claimed in claim 1, wherein the first and second fuel cells are substantially identical.

3. A fuel cell system as claimed in claim 1, wherein
the at least one reactant inlet line comprises a fuel inlet line and an oxidant inlet line;
the at least one output outlet comprises an anode output outlet and a cathode output outlet; and
the first heater arrangement comprises a first fuel heater associated with the fuel inlet line of the second fuel cell and a first oxidant heater associated with the oxidant inlet line of the second fuel cell.

4. A fuel cell system as claimed in claim 1, wherein the first heater arrangement includes an output outlet, the fuel cell system further comprising:
a third fuel cell having at least one reactant inlet line and at least one output outlet; and
a second heater arrangement operably connected to the at least one output outlet of the second fuel cell and to the output outlet of the first heater arrangement, and associated with the at least one reactant inlet line of the third fuel cell such that heat from the second heater arrangement is transferred to reactants in the at least one reactant inlet line of the third fuel cell.

5. A fuel cell system as claimed in claim 1, further comprising:
an inlet valve arrangement associated with the at least one reactant inlet line of the second fuel cell and located downstream from the first heater arrangement.

6. A fuel cell system as claimed in claim 5, wherein
the at least one reactant inlet line of the second fuel cell comprises a fuel inlet line and an oxidant inlet line;
the first heater arrangement comprises a first fuel heater associated with the fuel inlet line of the second fuel cell and a first oxidant heater associated with the oxidant inlet line of the second fuel cell; and
the inlet valve arrangement comprises a fuel inlet valve located downstream from the first fuel heater and an oxidant inlet valve located downstream from the first oxidant heater.

7. A fuel cell system as claimed in claim 6, further comprising:
a fuel isolation valve associated with the first fuel inlet line and located upstream from the first fuel heater and an oxidant isolation valve associated with the first oxidant inlet line and located downstream from the first oxidant heater.

8. A fuel cell system, comprising:
at least first and second individually operable fuel cells that consume reactants and produce power and output;
means for heating the reactants to be consumed by the second fuel cell with the output from the first fuel cell; and
means for sequentially activating the fuel cells.

9. A fuel cell system as claimed in claim 8, wherein the means for heating the reactants to be consumed by the second fuel cell with the output from the first fuel cell heats the reactants to be consumed by the second fuel cell at a location upstream from the second fuel cell.

10. A fuel cell system as claimed in claim 8, wherein the means for sequentially activating the fuel cells comprises means for activating the first fuel cell prior to the second fuel cell and activating the second fuel cell after the output from the first fuel cell has heated the reactants to be consumed by the second fuel cell to a predetermined temperature.

11. A fuel cell system as claimed in claim 10, further comprising:
a third individually operable fuel cell that consumes reactants and produces power and output; and
means for heating the reactants to be consumed by the third fuel cell with the output from at least the second fuel cell;
wherein the means for sequentially activating the fuel cells comprises means for activating the first fuel cell prior to the second fuel cell, activating the second fuel cell prior to the third fuel cell, and activating the third fuel cell after the output from the at least the second fuel cell has heated reactants to be consumed by the third fuel cell to a predetermined temperature.

12. A fuel cell system as claimed in claim 11, further comprising:
means for monitoring a load on the fuel cell system and preventing actuation of the third fuel cell until the load reaches a predetermined level.

13. A method of operating a fuel cell system including at least first and second fuel cells that consume reactants and produce power and output, the method comprising the steps of:
activating the first fuel cell without activating the second fuel cell;
heating reactants to be consumed by the second fuel cell with the output from the first fuel cell; and
activating the second fuel cell after the reactants to be consumed by the second fuel cell have been heated to a predetermined temperature.

14. A method as claimed in claim 13, wherein the step of activating the first fuel cell without activating the second fuel cell comprises supplying reactants to the first fuel cell without supplying reactants to the second fuel cell.

15. A method as claimed in claim 13, wherein the step of heating reactants to be consumed by the second fuel cell with the output from the first fuel cell comprises supplying the output from the first fuel cell to a heater and heating the reactants to be consumed by the second fuel cell with the heater.

16. A method as claimed in claim 13, wherein the step of heating reactants to be consumed by the second fuel cell with the output from the first fuel cell comprises isolating a quantity of reactants from other reactants and heating the isolated quantity of reactants with the output from the first fuel cell.

17. A method as claimed in claim 13, wherein the step of activating the second fuel cell comprises supplying the reactants to be consumed by the second fuel cell to the second fuel cell after the reactants have been heated to a predetermined level.

18. A method as claimed in claim 13, further comprising the step of:
determining whether a load has be placed on the fuel cell system;
wherein the step of activating the second fuel cell comprises activating the second fuel cell after the reactants to be consumed by the second fuel cell have been heated to a predetermined level and it has been determined that a load has been placed on the system.

19. A method as claimed in claim 18, wherein
the fuel cell system includes at least first, second and third fuel cells; and
the step of activating the first fuel cell comprises activating the first fuel cell without activating the second and third fuel cells.

20. A method as claimed in claim 19, wherein the step of activating the second fuel cell further comprises activating the second fuel cell without activating the third fuel cell.

21. A method as claimed in claim 20, further comprising the step of:
heating reactants to be consumed by the third fuel cell with the output from the second fuel cell.

22. A method as claimed in claim 21, further comprising the step of:
monitoring the load placed on the fuel cell system;
activating the third fuel cell in response the monitored load reaching a predetermined level.

23. A method as claimed in claim 22, further comprising the step of:
deactivating the third fuel cell in response the monitored load dropping below a predetermined level.

24. A system, comprising:
a power consuming apparatus; and
a fuel cell system having a pilot unit and a plurality of power units operably connected to the power consuming apparatus, the fuel cell system being operable in
(1) a standby state where the power units are not activated, the pilot unit is activated, and output from pilot unit heats reactants to be consumed by at least one of the power units, and
(2) a power supply state where at least one of the power units supplies power to the power consuming apparatus and output from the at least one power unit heats reactants to be consumed by at least one other power unit.

25. A system as claimed in claim 24, further comprising:
a reactant supply operably connected to the pilot unit and power units; and
a plurality of reactant valves respectively located between the reactant supply and the pilot and power units.

26. A system as claimed in claim 25, wherein the pilot unit includes a pilot unit fuel cell and the power units comprise respective power unit fuel cells, the system further comprising:
a controller, operably connected to the reactant valves, adapted to control the reactant valves to allow reactant flow to the pilot unit and to block reactant flow to the power units when the system is in the standby state.

27. A system as claimed in claim 26, wherein the controller is adapted to control the reactant valves to sequentially permit reactant flow to the power unit fuel cells when the system is in the power supply state.

28. A system as claimed in claim 26, wherein
the plurality of power units comprises at least first and second power units and the controller is adapted to permit reactant flow to the first power unit fuel cell and block reactant flow to the second power unit fuel cell when the system is initially placed in the power supply state; and
output from the first power unit fuel cell heats reactants to be consumed by the second power unit.

29. A system as claimed in claim 28, wherein controller is adapted to permit reactant flow to the second power unit fuel cell after the reactants to be consumed by the second power unit reach a predetermined temperature.

30. A system as claimed in claim 28, wherein controller is adapted to permit reactant flow to the second power unit fuel cell after the reactants to be consumed by the second power unit reach a predetermined temperature and a load imparted by the power consuming apparatus reaches a predetermined level.
